(19) United States
(12) Patent Application Publication
(10) Pub. No.: US 2024/0358193 A1
(43) Pub. Date: Oct. 31, 2024

(54) FLANGE-MOUNTED COOKING UTENSIL FOR FIRE PIT

(71) Applicant: Breeo, LLC, Kinzers, PA (US)

(72) Inventors: Christopher Boehmer, Shohola, PA (US); Amos Alan Allgyer, Gordonville, PA (US)

(21) Appl. No.: 18/618,678

(22) Filed: Mar. 27, 2024

Related U.S. Application Data
(60) Provisional application No. 63/462,981, filed on Apr. 29, 2023.
(60) Provisional application No. 63/551,999, filed on Feb. 9, 2024.

(51) Int. Cl. A47J 37/07; A47J 37/06; F24C 15/10

(52) U.S. Cl. CPC A47J 37/0786; A47J 37/067; A47J 37/0694; F24C 15/107

(57) ABSTRACT

A cooking utensil mounts to a fire pit flange. The cooking utensil has a grill-type or griddle-type body that is cantilevered over the fire box of the fire pit. Food can be cooked directly on the utensil body, or a cooking pot or cooking pan can be supported on the body. The cooking utensil has at least one downwardly-projecting arm that defines at least a portion of a mounting slot that receives a portion of the upper flange of the fire pit to mount the cooking utensil. In one configuration, the arm defines a second slot that mounts the cooking utensil in an arrangement where the cooking surface is tilted downwardly to drain material from the cooking surface into the fire of the fire pit.

### CROSS REFERENCE TO RELATED APPLICATIONS

This application claims the benefit of U.S. Provisional Patent application Nos. 63/462,981 filed Apr. 29, 2023, and 63/551,999 filed Feb. 9, 2024; the disclosures of both are incorporated herein by reference.

### BACKGROUND

Outdoor fire pits have long been popular to sit around and enjoy a campfire in one's backyard. Cooking food on outdoor fire pits is increasingly popular. Some fire pits include grill posts that support a grill above the fire box of the fire pit. These can hold multiple grills and allow the positions of the grills to be adjusted with respect to the fire pit. Another fire pit provides a wide cooking flange around the top of the fire pit.

### SUMMARY OF THE DISCLOSURE

The disclosure provides a cooking utensil that mounts to an upper flange of a fire pit. The cooking utensil has a grill-type or griddle-type body that is cantilevered over the fire box of the fire pit. Food can be cooked directly on the utensil body, or a cooking pot or cooking pan can be supported on the body. The cooking utensil has at least one downwardly-projecting arm that defines at least a portion of a mounting slot that receives a portion of the upper flange of the fire pit to mount the cooking utensil. In one configuration, the arm defines a second slot that mounts the cooking utensil in an arrangement where the cooking surface is tilted downwardly to drain material from the cooking surface into the fire of the fire pit.

The disclosure provides a cooking utensil configuration having a body with a pair of arms projecting of the outer portions of the sides of the body. Each arm defines a slot between the arm and the edge of the body. The slot is sized to receive a portion of the outwardly projecting flange at the top of a fire pit. When the utensil is slid onto the flange with the arms below the flange, the body of the utensil is cantilevered over the fire box and is secured against tipping into the fire box.

The disclosure provides another configuration of the arms that define two spaced slots. The use of the top slot positions a cooking surface horizontally while the use of a lower slot tilts the cooking surface towards the fire box so that grease and cooking juices will flow into the fire.

The disclosure provides a utensil with one or more outer handles that are spaced from the fire pit during use of the utensil so that the handles remain cooler than the body. This allows a user to adjust the position of the utensil during cooking. The outer handles also allow the user to remove the utensil from the fire pit.

When the utensil is cool, an inner arm that is the same height as the two side arms that secure the utensil to the flange allows the utensil to sit level on a surface such as a table top. The user can use the utensil in this configuration as a trivet to support hot cooking pots or hot cooking pans.

The disclosure provides a griddle configuration having walls along three sides of a griddle surface with gaps and an opening provided to drain grease from the griddle surface into the fire.

The disclosure provides a configuration with a removable heat shield.

The preceding non-limiting aspects of the disclosure, as well as others, are more particularly described below. A more complete understanding of the devices, assemblies, and methods can be obtained by reference to the accompanying drawings, which are not intended to indicate relative size and dimensions of the assemblies. In those drawings and the description below, like numeric designations refer to components of like function. Specific terms used in that description are intended to refer only to the particular structure of the embodiments selected for illustration in the drawings and are not intended to define or limit the scope of the disclosure.

### DESCRIPTION OF THE FIGURES OF THE DRAWING

FIG. 1 is a front upper perspective view of a first embodiment of a flange-mounted grill for fire pit.

FIG. 2 is a front elevation view thereof.

FIG. 3 is a rear elevation view thereof.

FIG. 4 is a left side elevation view thereof.

FIG. 5 is a right-side elevation view thereof.

FIG. 6 is a top plan view thereof.

FIG. 7 is a bottom plan view thereof.

FIG. 8 is a perspective view of the flange-mounted grill of FIG. 1 mounted to a fire pit.

FIG. 9 is a perspective view of a user adjusting the position of the grill of FIG. 1 using the outer handle.

FIG. 10 is a perspective view of the grill used as a trivet.

FIG. 11 is a perspective view of a third embodiment of a griddle for a fire pit mounted on the flange of a fire pit in a flat configuration.

FIG. 12 is a front elevation view thereof.

FIG. 13 is a side elevation view thereof.

FIG. 14 is a front view of the third embodiment of the griddle for a fire pit mounted on the flange of a fire pit in an angled configuration.

FIG. 15 is a side elevation view thereof.

FIG. 16 is a perspective view of the griddle of FIG. 11.

FIG. 17 is a front elevation view thereof.

FIG. 18 is a rear elevation view thereof.

FIG. 19 is a left side view thereof.

FIG. 20 is a right-side view thereof.

FIG. 21 is a top plan view thereof.

FIG. 22 is a bottom plan view thereof.

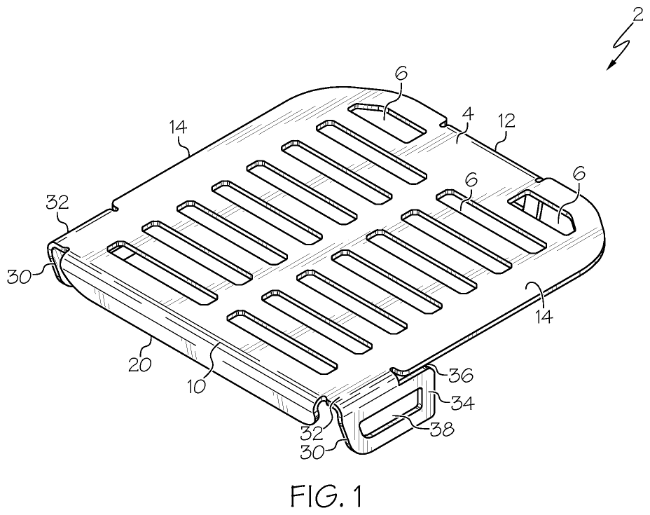

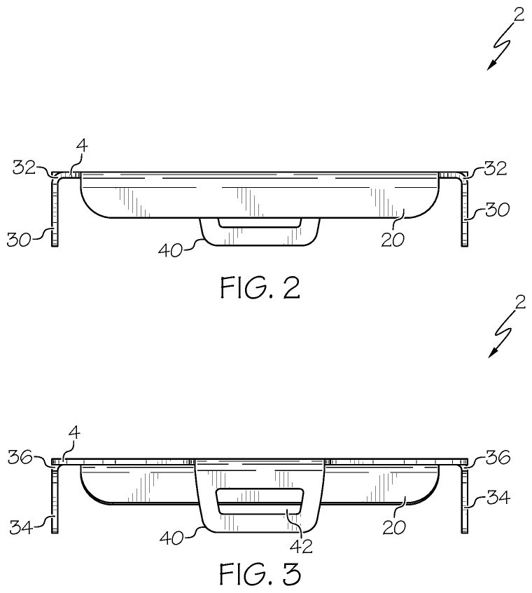

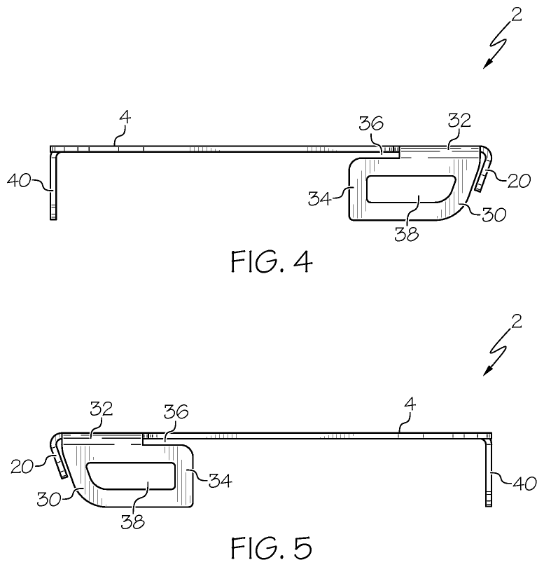

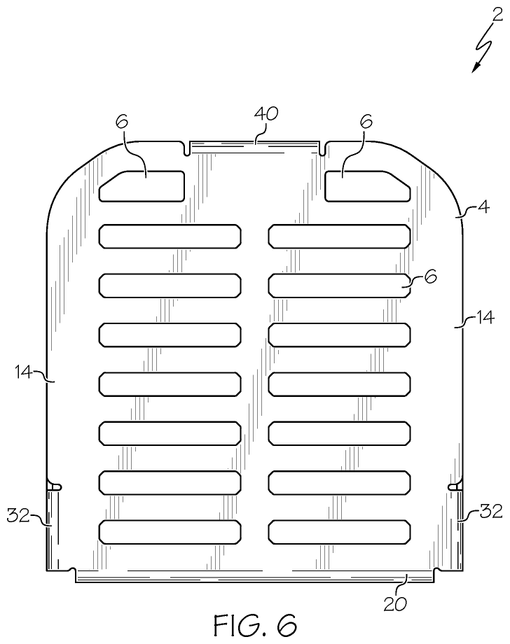

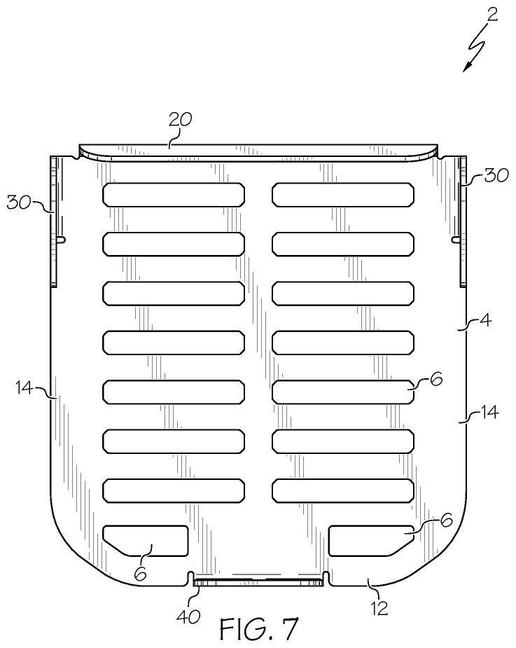

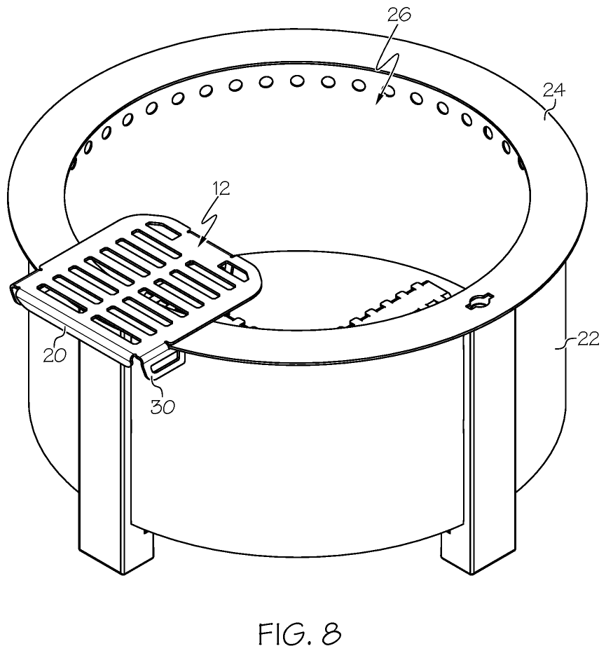

### DETAILED DESCRIPTION OF THE DISCLOSURE

This description of exemplary embodiments is intended to be read in connection with the accompanying drawings, which are to be considered part of the entire written description. The drawing figures are not necessarily to scale and certain features may be shown exaggerated in scale or in somewhat schematic form in the interest of clarity and conciseness. In the description, relative terms such as “horizontal,” “vertical,” “up,” “down,” “top” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “joined,” “connected,” and “interconnected,” refer to a relationship wherein structures are secured or attached to one another either directly or indirectly through intervening structures, as well as both movable or rigid attachments or relationships, unless expressly described otherwise.

The disclosure provides first and second embodiments of a cooking utensil 2 that can be used for cooking food upon, for supporting other cooking utensils such as pots and pans, and for use as a trivet. The first embodiment of utensil 2 is depicted in the drawings and has a body 4 that defines a plurality of openings 6 such that body 4 functions as a grill. The second embodiment does not have openings 6 and functions as a griddle. In both embodiments, utensil 2 is made from a metal such as stainless steel, steel, or aluminum. The material is thick enough for utensil 2 to support a heavy pot of water or a cast iron skillet loaded with potatoes. Eleven gauge or thicker steel in the configuration described below provides sufficient strength.

Utensil 2 includes body 4 which is flat and includes an outer end 10, an inner end 12, and side edges 14. Body 4 includes an upper surface and a lower surface. Body 4 can be provided as a solid plate or a plate that defines openings 6. These can be formed by removing material from the plate. Body 4 also can be formed from a plurality of strips of material that cross one another to define openings therebetween. Openings 6 can be provided in a variety of shapes and sizes. The drawings depict a non-limited exemplary embodiment. Body 4 without openings functions as a sear plate or a griddle while body 4 with openings 6 functions as a grill or a pot holder.

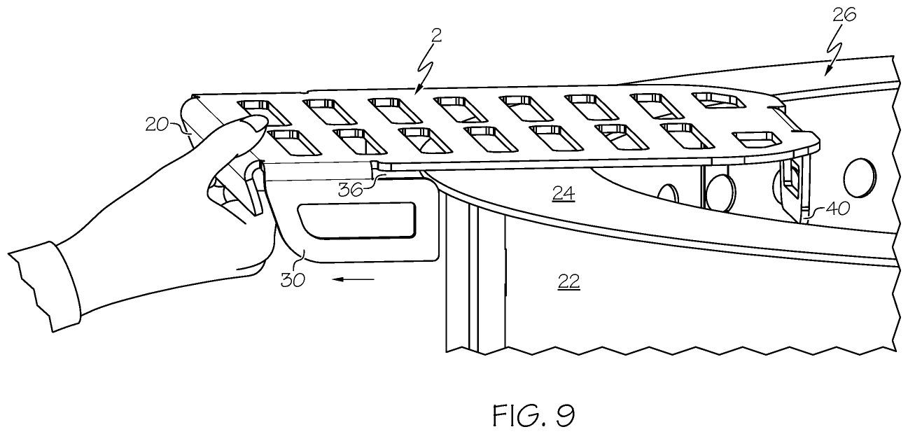

An outer handle 20 projects down from outer end 10. Outer handle 20 also can be angled inwardly ten to twenty degrees. As shown in FIGS. 8 and 9, handle 20 is spaced from both the side 22 and flange 24 of fire pit 26. This spacing allows handle 20 to remain cool during use so that the user can grasp utensil 2 by handle 20 to position utensil 2 or to remove it from fire pit 26. Outer handle 20 is integral with body 4 and formed by bending a tab of material. Outer handle 20 also can be welded to body 4 or connected with fasteners.

At least one arm 30 projects down from body 4 and defines at least a portion of a mounting slot 36. In one exemplary configuration, arm 30 can extend across outer end 10 and also function as handle 20. In the exemplary configuration depicted in the drawings, a pair of arms 30 project down from the outer portions of side edges 14. Each arm 30 can be perpendicular to body 4. Arms 30 can be integral with body 4 and formed by bending tabs of material. Arms 30 also can be welded to body 4 or connected with fasteners. Each arm 30 is connected to body 4 at a shoulder 32 (when arms are integral, shoulder 32 includes the bent material). Each arm 30 includes an extension 34 that projects forward toward inner end 12 of body 4 to define a slot 36 between arm 30 and side edge 14 of body 4. Slot 36 has a width greater than the thickness of flange 24 so that utensil 2 can be mounted to fire pit 26 by sliding arm extensions 34 under flange 24 as shown in FIG. 8. Each arm 30 can define an opening 38.

Shoulders 32 define the ends of slots 36. Shoulders 32 extend inwardly no more than twenty-five percent of the length of body 4 to allow for at least seventy-five percent of the length of body 4 to extend over flange 24 and over the fire box of fire pit 26.

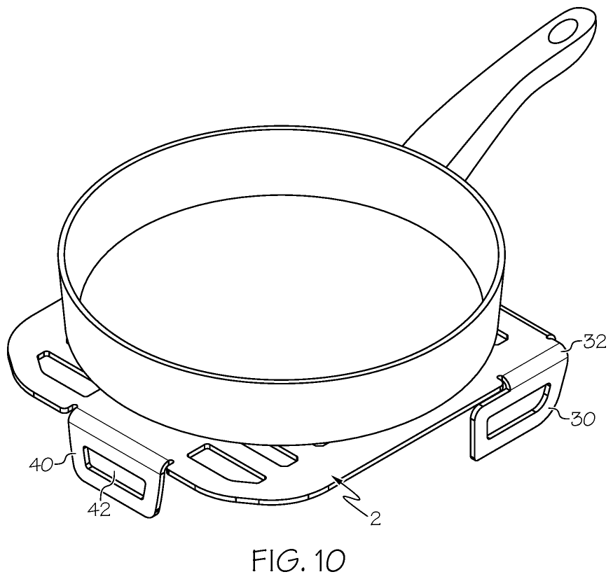

Utensil 2 also includes an inner arm 40 that has the same height as arms 30. Inner arm 40 is connected to body 4 at inner end 12. Inner arm 40 can be integral with body 4 and formed by bending a tab of material. Inner arm 40 also can be welded to body 4 or connected with fasteners. Inner arm also defines an opening 42. Inner arm 40 cooperated with arms 30 to define a tripod to support body 4 above a surface so that utensil 2 can be used a trivet as shown in FIG. 10.

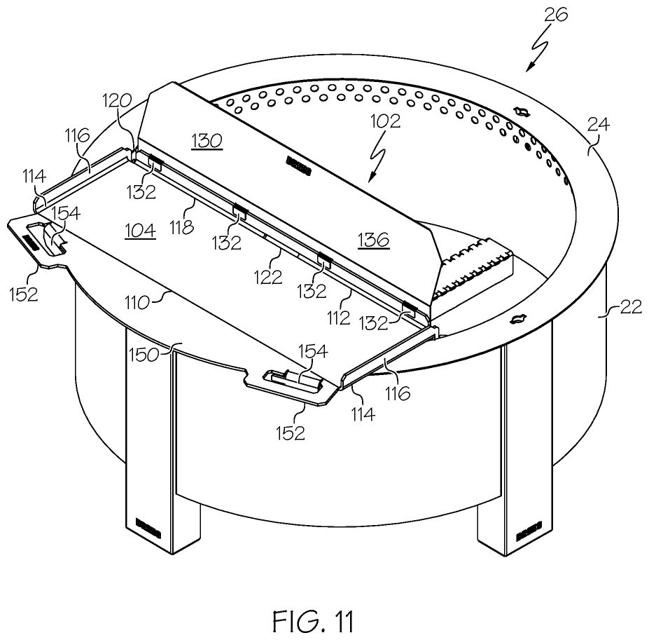

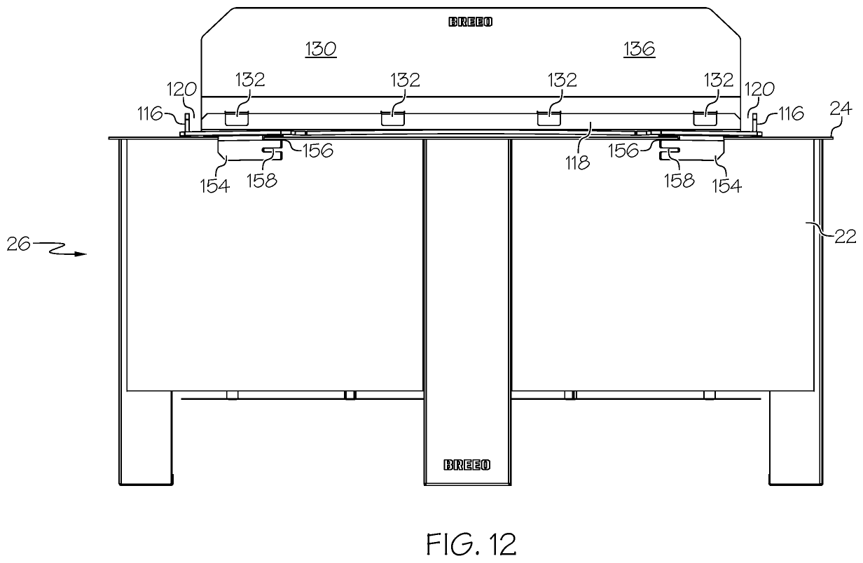

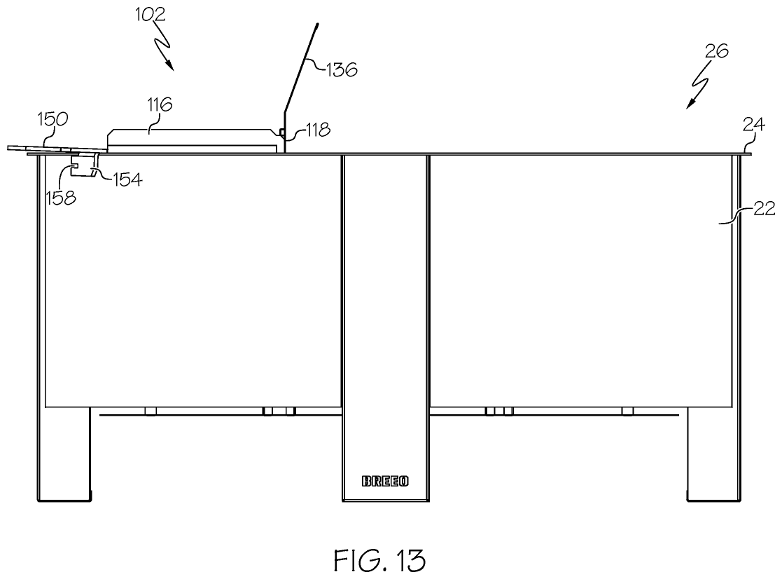

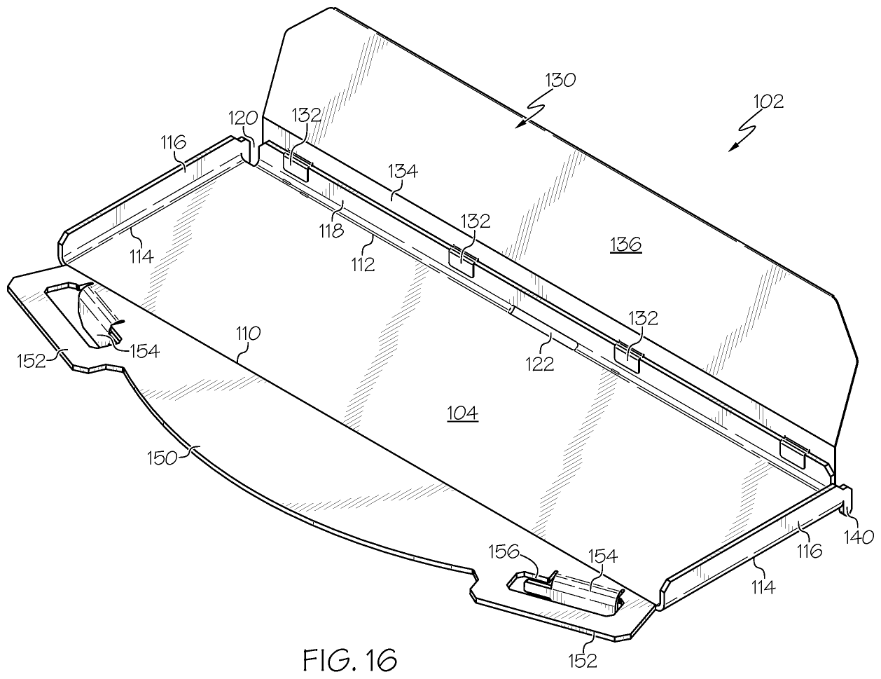

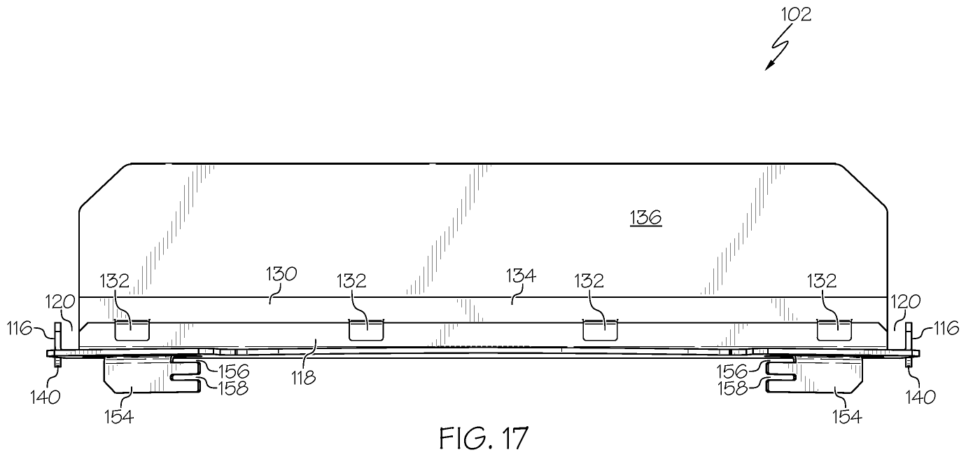

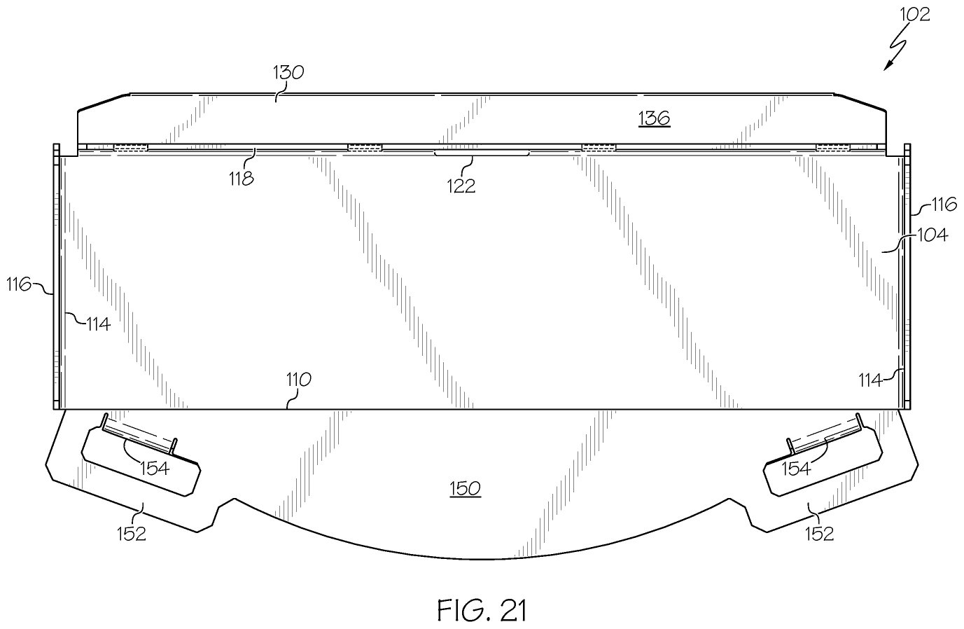

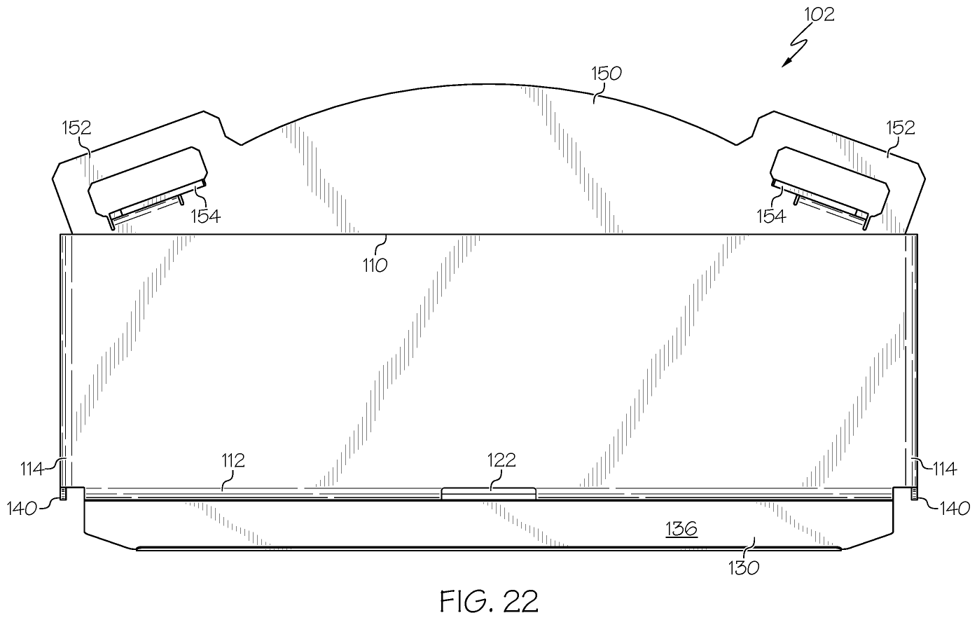

The third embodiment of a fire pit cooking utensil is indicated by number 102 in FIGS. 11-22. In the embodiment depicted in the drawings, utensil 102 is in the form of a griddle or sear plate. In other configurations, the cooking surface of utensil 102 can have a plurality of openings so that utensil 102 functions as a grill. In the exemplary configuration, cooking utensil 102 has a solid flat griddle plate 104 that provides the griddle cooking surface. Cooking utensil 102 is made from a metal such as stainless steel, steel, or aluminum. The material is thick enough for utensil 102 to support a heavy pot of water. Eleven gauge or thicker steel in the configuration described below provides sufficient strength.

Plate 104 has an outer end 110, an inner end 112, and side edges 114. Plate 104 includes an upper surface and a lower surface. Plate 104 is provided as a solid plate that can function as a sear plate or as a griddle. Side walls 116 project up from side edges 114. An inner wall 118 projects up from inner end 112. Notches 120 are defined in the corners between each side wall 116 and the ends of inner wall 118. Notches allow grease from the griddle surface to drip into the fire. In addition to notches 120, a slot 122 is defined between plate 104 and inner wall 118 to allow scrapings and grease to be moved from the griddle surface into the fire.

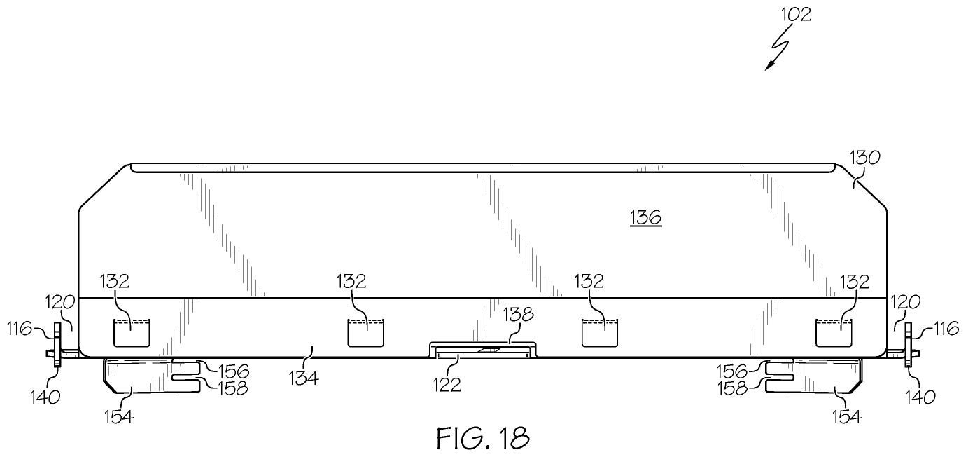

A heat shield 130 is removably mountable to inner wall 118. A plurality of L-shaped mounting fingers 132 slide over the top of inner wall 118 to mount heat shield. Mounting fingers 132 project from a lower wall 134 of heat shield 130. An upper wall 136 is angled rearwardly fifteen to thirty degrees toward the fire box to deflect heat away from the top of body 104. Heat shield 130 keeps the full heat of the fire away from the user's hands while the user is working on the griddle surface. In some configurations, lower wall 134 defines a notch 138 (FIG. 18) that is aligned with slot 122.

Tabs 140 project down from the inner ends of side walls 114. Tabs 140 function as stops that prevent utensil 102 from sliding off flange 124. When utensil 102 is sized to match flange 24, tabs 140 are engaged with or are closely adjacent the inner edge of flange 24 as shown in FIG. 11 to limit the movement of utensil 102. Tabs 140 also can be lengthened to function in the same way as inner arm 40 from above to allow utensil 102 to function as a trivet.

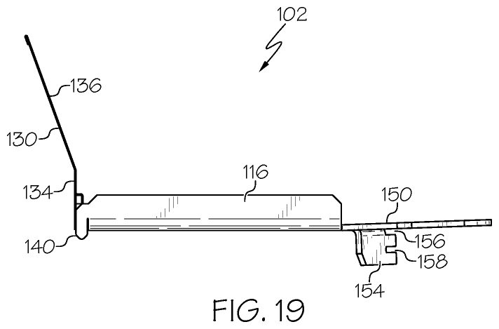

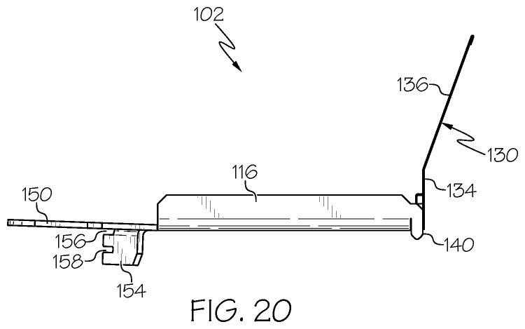

An outer panel 150 extends from outer end 110 of plate 104. One or more handles 152 are integrally formed in outer panel 150 or are connected thereto with fasteners. Handles are located outwardly of flange 24 to help them to remain cool. In the exemplary configuration, two handles 152 are integrally formed with outer panel 150. Each handle 152 is partially defined by an opening. Outer panel 150 prevents grease from readily flowing over the outer edge of fire pit 26. Outer panel 150 is angled upwardly as shown in FIGS. 19 and 20 with respect to plate 104.

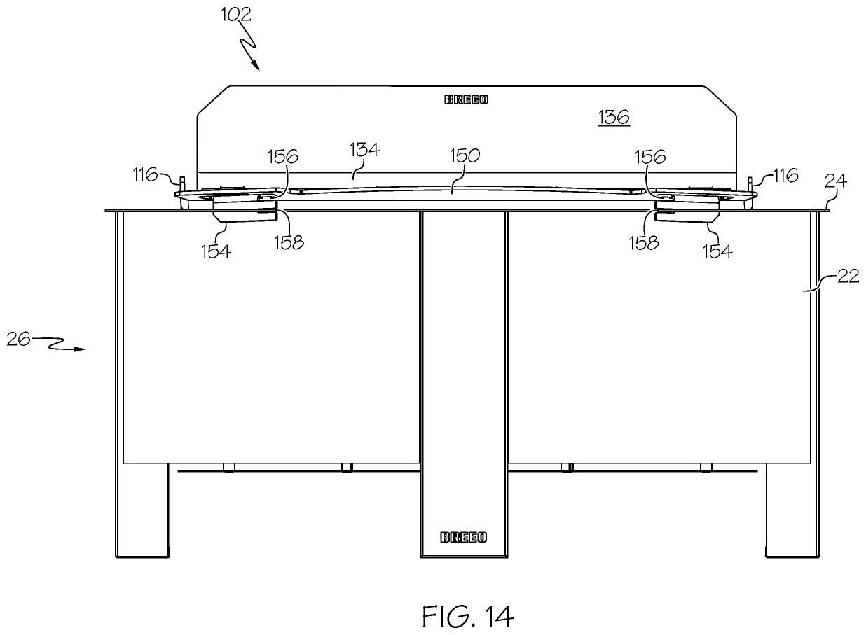

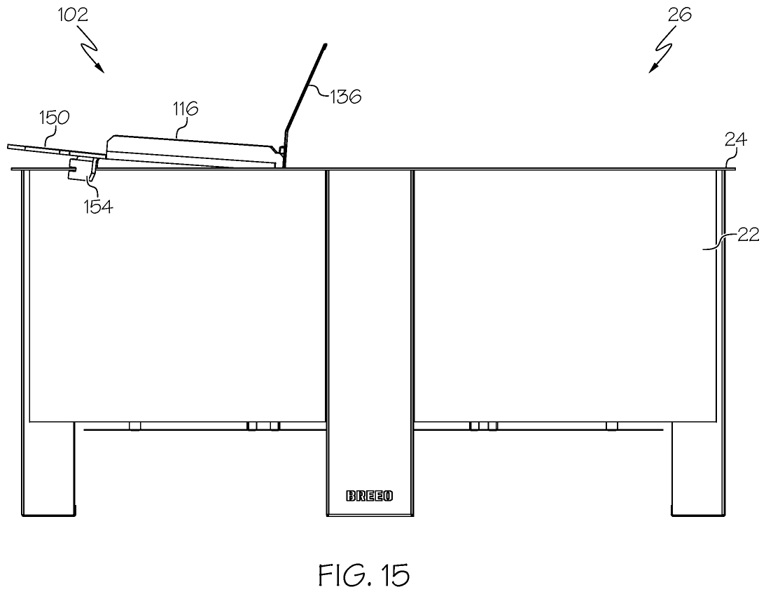

At least one arm 154 projects downward from the body of utensil 102. Arm 154 at least partially defines a mounting slot 156 that receives a portion of flange 24 to mount utensil 102. In the exemplary configuration, two spaced arms 154 project down from outer plate 150. In the exemplary configuration, arms 154 are formed by bending material down to form the openings of handles 152. Arms 154 define first 156 and second 158 spaced slots that receive flange 24 to connect utensil 102 to fire pit 26. First slot 156 is above second slot 158. Slots 156 provide a flat mounted configuration shown in FIGS. 11-13 and slots 158 provide an angled configuration as shown in FIGS. 14-15. In the angled configuration, outer end 110 of plate 104 is lifted up to tilt plate 104 inwardly. The angled configuration helps grease and cooking debris to move toward inner wall 118. In this configuration, arms 154 face each other with their inner ends that define slots 156 and 158 facing each other and being configuration to allow portions of flange 24 to slide into the slots. Utensil 102 is mounted to fire pit 26 by placing plate 104 over flange 24 and sliding utensil 102 inwardly until flange 24 is located in slots 156 or 158. When utensil 102 is moved far enough to locate flange 24 in slots 156 or 158, tabs 140 slide over the inner edge of flange 24 to further secure utensil 102 to fire pit 26. Utensil 102 is then heated by the fire in fire pit 16 and the user can cook on plate 104.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the above description and attached illustrations are examples and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps. Up, down, left, right, top, and bottom are in reference to the orientation of the drawings.

1. A cooking utensil for use with a cooking device having a flange; the cooking utensil comprising:
a body defining a cooking surface;
a first arm projecting downwardly from the body;
the first arm at least partially defining a first mounting slot adapted to receive a portion of the flange of the cooking device to mount the cooking utensil to the cooking device.

2. The cooking utensil of claim 1, wherein the body defines a plurality of openings to define a grill cooking surface.

3. The cooking utensil of claim 1, wherein the body defines a solid flat cooking surface to define a griddle.

4. The cooking utensil of claim 1, wherein the first arm defines a second mounting slot spaced from the first mounting slot.

5. The cooking utensil of claim 4, wherein the first mounting slot is located between the body and the second mounting slot.

6. The cooking utensil of claim 1, further comprising a heat shield removably connected to the body.

7. The cooking utensil of claim 6, wherein the body includes first and second sidewalls along side edges of the cooking surface and an inner wall along an inner end of the cooking surface.

8. The cooking utensil of claim 7, wherein the heat shield is removably connected to the inner wall.

9. The cooking utensil of claim 7, wherein open notches are defined between inner ends of the sidewalls and the inner wall.

10. The cooking utensil of claim 9, wherein an opening is defined by the body adjacent the inner wall.

11. The cooking utensil of claim 7, further comprising a tab projecting down from an inner end of each of the sidewalls.

12. The cooking utensil of claim 1, wherein the body includes an outer panel projecting outwardly from an outer edge of the cooking surface; the arm projecting down from the outer panel.

13. The cooking utensil of claim 1, further comprising a handle connected to the body.

14. The cooking utensil of claim 1, further comprising a second arm at least partially defining a second mounting slot adapted to receive another portion of the flange of the cooking device to mount the cooking utensil to the cooking device; the second arm being spaced from the first arm.

15. The cooking utensil of claim 14, wherein the cooking surface has parallel side edges; the first and second arms being parallel to the side edges.

16. The cooking utensil of claim 1, further comprising an inner arm projecting down from an inner end of the body.

17. A cooking device comprising:
a body having a sidewall that defines a fire box inwardly of the sidewall;
a flange located at a top end of the sidewall; and
a cooking utensil mounted to the flange; the cooking utensil having a cooking surface extending over the fire box.

18. The device of claim 17, wherein the cooking utensil includes an arm that defines a first mounting slot; a portion of the flange located in the first mounting slot to mount the cooking utensil to the flange.

19. The device of claim 18, wherein the arm defines a second mounting slot spaced from an located lower than the first mounting slot; the cooking surface being angled downwardly and inwardly toward the fire box when the cooking utensil is mounted to the flange with a portion of the flange is located in the second mounting slot.

20. The device of claim 17, further comprising a heat shield removably connected to the cooking utensil.
